(19) United States
(12) Patent Application Publication
(10) Pub. No.: US 2026/0307654 A1
(43) Pub. Date: Oct. 8, 2026

(54) HYBRID ELECTRIC VEHICLE AND A DRIVING CONTROL METHOD THEREFOR

(71) Applicants: HYUNDAI MOTOR COMPANY, Seoul (KR); KIA CORPORATION, Seoul (KR)

(72) Inventor: Dong Sun Kim, Hwaseong-si (KR)

(73) Assignees: HYUNDAI MOTOR COMPANY, Seoul (KR); KIA CORPORATION, Seoul (KR)

(21) Appl. No.: 19/326,593

(22) Filed: Sep. 11, 2025

(30) Foreign Application Priority Data
Apr. 2, 2025 (KR) 10-2025-0043098

(51) Int. Cl. B60W 30/188; B60W 50/14

(52) U.S. Cl. CPC B60W 30/1882; B60W 50/14; B60W 2420/403; B60W 2540/10; B60W 2540/12; B60W 2555/20; B60W 2710/021; B60W 2710/0677; B60W 2710/086

(57) ABSTRACT

A hybrid electric vehicle includes a hybrid powertrain having an engine and a drive motor. The hybrid electric vehicle also includes a control unit configured to determine whether a road ahead of the vehicle is flooded and adjust working points of the drive motor and the engine according to an output demanded by a driver, based on a required exhaust pressure of the engine needed to prevent flooding through an exhaust outlet, in response to determining that the road is flooded.

### CROSS-REFERENCE TO RELATED APPLICATION

The present application claims the benefit of and priority to Korean Patent Application No. 10-2025-0043098, filed on Apr. 2, 2025, the entire contents of which are hereby incorporated herein by reference.

### BACKGROUND

### Field of the Disclosure

The present disclosure relates to a hybrid electric vehicle and a driving control method therefor.

### Description of Related Art

Driving a vehicle on a flooded road may significantly affect not only driver safety but also vehicle durability. For example, when a road is flooded, water may enter the vehicle's engine or exhaust system, which causes engine damage. To prevent such issues, technology for properly managing the exhaust system pressure of the vehicle is important. Exhaust pressure plays a critical role in the normal operation of the engine, and maintaining pressure to prevent water from entering the exhaust system is a key technology that enables the vehicle to safely pass through a flooded road.

In existing vehicle systems, a control method is used to optimize fuel efficiency and performance by utilizing a hybrid system that uses both an engine and a motor. A hybrid electric vehicle adjusts the output of the engine and motor to provide the driving force demanded by the driver, with a focus on improving fuel efficiency. However, in such systems, the engine may automatically shut down when driving on a flooded road. In particular, due to the characteristic of the system to minimize the output of the engine under low-speed driving conditions, there is a risk of water entering the exhaust system.

The issue with this existing technology is that, during driving on a flooded road, the engine may lose power or water may enter the exhaust system and cause engine damage. In vehicles like hybrid electric vehicles (HEVs), the cooperation between the engine and motor is crucial. When the system lowers or shuts down the output of the engine, the risk of water entering the exhaust system increases.

The above description of the related art is intended to provide a better understanding of the background of the present disclosure and should not be taken as an admission of prior art known to those of ordinary skill in the art.

### SUMMARY

To solve the above problem, embodiments of the present disclosure provide a technology that may accurately detect the state of the engine and exhaust system and adjust the engine's working point accordingly. On a flooded road, embodiments of the present disclosure may increase exhaust pressure to prevent water from entering the exhaust system. To achieve this, embodiments of the present disclosure provide a system capable of real-time monitoring and adjustment of vehicle speed, engine RPM, and exhaust pressure. In addition, the cooperative operation between the motor and the engine is also important, and embodiments of the present disclosure provide a control method that allows the required output to be provided through the motor to meet the driver's demands.

Therefore, embodiment of the present disclosure may provide safe driving on a flooded road by effectively controlling the vehicle's exhaust pressure and avoiding engine damage. Embodiments of the present disclosure may thus improve vehicle durability and driver safety.

Embodiments of the present disclosure provide a hybrid electric vehicle and a driving control method that enable safe driving on a flooded road, manage exhaust pressure properly to prevent water from entering an exhaust system of an engine, and realize an output that meets a driver's demand through cooperation between the engine and motor.

The technical problems to be addressed by the present disclosure are not limited to the technical problems described above. Other technical problems not mentioned herein should be more clearly understood by those having ordinary skill in the art to which the present disclosure pertains from the description below.

According to an embodiment of the present disclosure, a hybrid electric vehicle is provided. The hybrid electric vehicle includes a hybrid powertrain having an engine and a drive motor. The hybrid electric vehicle also includes a control unit configured to i) determine whether a road ahead of the hybrid electric vehicle is flooded and ii) adjust working points of the drive motor and the engine of an output demanded by a driver, based on a required exhaust pressure of the engine to avoid flooding through an exhaust outlet, in response to determining that the road ahead is flooded.

In an embodiment, the hybrid electric vehicle may further include a camera configured to acquire a road surface image of the road ahead. The control unit may be configured to receive road surface image information from the camera and determine whether the road ahead of the hybrid electric vehicle is flooded based on the road surface image information.

In an embodiment, the control unit is further configured to, in response to determining that the road ahead is flooded, output information prompting the driver to input a crossing mode transition through a display device of the vehicle.

In an embodiment, the control unit may be configured to determine the required exhaust pressure of the engine based on a difference between a water depth of the road ahead and a height of the exhaust outlet of the hybrid electric vehicle.

In an embodiment, the control unit may be configured to, in response to determining that exhaust pressure at the working point of the engine based on the output demanded by the driver is higher than or equal to the required exhaust pressure of the engine, maintain the working point of the engine based on the output demanded by the driver.

In an embodiment, the control unit may be configured to, in response to determining that exhaust pressure at the working point of the engine based on the output demanded by the driver is lower than the required exhaust pressure of the engine, i) adjust the working point of the engine based on the output demanded by the driver to a working point configured to achieve the required exhaust pressure and ii) adjust the working point of the drive motor so that a difference between the output of the engine based on the adjusted working point of the engine and the output demanded by the driver is output from the drive motor.

In an embodiment, the hybrid electric vehicle may further include an engine clutch, arranged between the engine and the drive motor and configured to selectively connect the engine and the drive motor. The control unit may be configured to, in response to determining that the output demanded by the driver is within an available output of the drive motor, i) disengage the engine clutch, ii) adjust the working point of the engine based on the output demanded by the driver to a working point configured to achieve the required exhaust pressure, and iii) adjust the working point of the drive motor to correspond to the output demanded by the driver.

In an embodiment, the hybrid powertrain may further include a generator motor. The control unit may be configured to, in response to determining that exhaust pressure at the working point of the engine based on the output demanded by the driver is lower than the required exhaust pressure of the engine needed, i) adjust the working point of the engine based on the output demanded by the driver to a working point configured to achieve the required exhaust pressure, ii) adjust the working point of the generator motor so that an output of the engine based on the adjusted working point of the engine is output from the generator motor, and iii) adjust the working point of the drive motor so that the output demanded by the driver is output from the drive motor.

In an embodiment, the working points of the drive motor and the engine based on the output demanded by the driver may be higher than or equal to the working point required for the engine to achieve the required exhaust pressure.

According to another embodiment, a method of driving control for a hybrid electric vehicle is provided. The method includes determining, by a control unit, whether a road ahead of the hybrid electric vehicle is flooded. The method also includes determining, by the control unit, a required exhaust pressure of the engine to avoid flooding through an exhaust outlet, in response to determining that the road ahead is flooded. The method additionally includes adjusting, by the control unit, working points of an engine and a drive motor based on an output demanded by a driver based on the required exhaust pressure.

In an embodiment, determining whether the road ahead of the vehicle is flooded may include i) receiving, by the control unit, road surface image information from a camera configured to acquire a road surface image of the road ahead of the hybrid electric vehicle and ii) determining whether the road ahead is the flooded road based on the road surface image information.

In an embodiment, the method may further include, in response to determining that the control unit determines that the road ahead is the flooded road, outputting, by the control unit, information prompting the driver to input a crossing mode transition through a display device of the vehicle.

In an embodiment, determining the required exhaust pressure of the engine may include determining the required exhaust pressure of the engine based on a difference between a water depth of the road ahead and a height of the exhaust outlet of the hybrid electric vehicle.

In an embodiment, adjusting the working points of the engine and the drive motor may include, in response to determining that exhaust pressure at the working point of the engine based on the output demanded by the driver is higher than or equal to the required exhaust pressure of the engine, maintaining the working point of the engine based on the output demanded by the driver.

In an embodiment, adjusting the working points of the engine and the drive motor may include, in response to determining that exhaust pressure at the working point of the engine based on the output demanded by the driver is lower than the required exhaust pressure of the engine, i) adjusting the working point of the engine based on the output demanded by the driver to a working point configured to achieve the required exhaust pressure and ii) adjusting the working point of the drive motor so that a difference between an output of the engine based on the adjusted working point of the engine and the output demanded by the driver is output from the drive motor.

In an embodiment, adjusting the working points of the engine and the drive motor may include, in response to determining that the output demanded by the driver is within an available output of the drive motor, i) disengaging an engine clutch arranged between the engine and the drive motor and configured to selectively connect the engine and the drive motor, ii) adjusting the working point of the engine based on the output demanded by the driver to a working point configured to achieve the required exhaust pressure, and iii) adjusting the working point of the drive motor to correspond to the output demanded by the driver.

In an embodiment, adjusting the working points of the engine and the drive motor, in response to determining that exhaust pressure at the working point of the engine based on the output demanded by the driver is lower than the required exhaust pressure of the engine, i) adjusting the working point of the engine based on the output demanded by the driver to a working point configured to achieve the required exhaust pressure, ii) adjusting the working point of the generator motor so that an output of the engine based on the adjusted working point of the engine is output from the generator motor, and iii) adjusting the working point of the drive motor so that the output demanded by the driver is output from the drive motor.

In an embodiment, the working points of the drive motor and the engine based on the output demanded by the driver may be higher than or equal to the working point required for the engine to achieve the required exhaust pressure.

According to embodiments, the hybrid electric vehicle and the method of driving control for a hybrid electric vehicle are capable of preventing water from entering the engine exhaust system by properly adjusting the exhaust pressure on a flooded road, and of stably providing an output demanded by the driver through cooperation between the engine and the motor. In addition, this enables safe driving on the flooded road, prevents engine damage, and improves vehicle durability.

The effects of the present disclosure are not limited to those described above. Other undescribed effects should be more clearly understood by those having ordinary skill in the art from the following description.

### BRIEF DESCRIPTION OF THE DRAWINGS

FIG. 1 is a view showing a hybrid powertrain of a hybrid electric vehicle according to an embodiment of the present disclosure.

FIG. 2 is a view showing a control unit of a hybrid electric vehicle according to an embodiment of the present disclosure.

FIG. 3 is a view showing an operation of a hybrid powertrain through a control unit when a hybrid electric vehicle crosses a flooded road according to an embodiment of the present disclosure.

FIG. 4 is a flowchart showing a method of driving control for a hybrid electric vehicle according to an embodiment of the present disclosure.

FIG. 5 is a detailed flowchart showing the method of driving control for a hybrid electric vehicle in FIG. 4 according to an embodiment of the present disclosure.

FIG. 6 is a flowchart showing a method of determining whether a road is flooded in the method of driving control for a hybrid electric vehicle in FIG. 5 according to an embodiment of the present disclosure.

FIG. 7 is a flowchart showing a method of computing required exhaust pressure in the method of driving control for a hybrid electric vehicle in FIG. 5 according to an embodiment of the present disclosure.

FIG. 8 is a flowchart showing a method of computing an engine working point for achieving the required exhaust pressure in the method of driving control for a hybrid electric vehicle in FIG. 5 according to an embodiment of the present disclosure.

FIGS. 9 and 10 are flowcharts showing a method of controlling an engine and a motor of a hybrid powertrain in the method of driving control for a hybrid electric vehicle in FIG. 5 according to an embodiment of the present disclosure.

### DETAILED DESCRIPTION

In describing embodiments disclosed in the present specification, where it was determined that a detailed description of a known related art would obscure the gist of the present disclosure, the detailed description thereof has been omitted herein. In addition, the accompanying drawings are provided to enhance understanding of the embodiments disclosed in the present specification. The technical spirit disclosed in the present specification is not limited by the accompanying drawings. Rather, it should be understood that the present disclosure includes all modifications, equivalents, and substitutes included in the spirit and scope of the present disclosure. The description herein is not intended to limit the present disclosure to the form or specific field described, and it should be understood that various alternative aspects and modifications to the present disclosure, whether explicitly stated or implied in this specification, are possible. Those having ordinary skill in the art to which the present disclosure pertains should recognize that the form and details of the present disclosure may be subject to change.

The present disclosure is described with reference to example embodiments. However, as should be understood by those having ordinary skill in the art to which the present disclosure pertains, various embodiments disclosed in the present specification may be modified or otherwise implemented in various other ways without departing from the spirit and scope of the present disclosure. Accordingly, the description below is illustrative, and is intended to enable those having ordinary skill in the art to which the present disclosure pertains to make and use various embodiments. It should be understood that the forms of the present disclosure shown and described in the present specification are representative embodiments. Equivalent elements, materials, processes, or steps may be substituted for those illustrated and described in the present disclosure. Expressions such as “including,” “comprising,” “incorporating,” “consisting of,” “have,” and “is,” as used in describing embodiments of the present disclosure, should be interpreted in a non-exclusive manner, namely as allowing for the inclusion of items, components, or elements not explicitly listed. References to the singular should be interpreted as including references to the plural.

The various embodiments disclosed in the present specification should be understood in an illustrative and descriptive sense and should not be interpreted as limiting the present disclosure. Any reference to joining (e.g., attached, affixed, coupled, connected, etc.) is used merely to enhance understanding of the present disclosure and is not intended to limit the position, orientation, or use of any configuration or method disclosed in the present specification. Therefore, when references to joining exist, the references should be interpreted broadly. Furthermore, these references to joining do not necessarily imply that two or more elements are directly connected to each other. Additionally, all numerical terms, such as “first,” “second,” “third,” “primary,” “secondary,” “main,” or any other arbitrary general terms or numerical terms, should be taken only as identifiers to aid in understanding the various components, forms, variations, or modifications of the present disclosure, and are not intended to imply any limitation to any component, form, variation, or modification, or to any order or preference thereof. In other words, these expressions may be used to describe various components, but the components are not limited by these expressions. The terms are used only for the purpose of distinguishing one component from another component.

As used in the description below, suffixes “module” and “part” for a component are used or interchangeably used solely for ease of preparation of the specification, and do not have different meanings and each of them does not function by itself.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component.

In addition, a unit or control unit included in names such as a motor control unit (MCU) is only a term widely used in the naming of a controller that controls the specific function of a vehicle, but does not mean a generic function unit.

A controller may include a communication device for communicating with other control units or sensors to control a responsible function, memory for storing an operating system, a logic command, and input/output information, and one or more processors for performing determination, calculation, and decision which are necessary for controlling the responsible function.

Any number of components or various components from any of the configurations described in the present specification may be included within the disclosure set forth in the present specification. Components may include any combination of the features described in the present specification and be arranged in any configuration among the various configurations described in the present specification. The concepts relating to the structure and arrangement of the components of the present disclosure, as well as their use and operation, may be applied not only to the specific embodiments discussed in the present specification but also to any number of embodiments in any combination. Embodiments, including those having various features in various arrangements, are described below with reference to the drawings.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus.

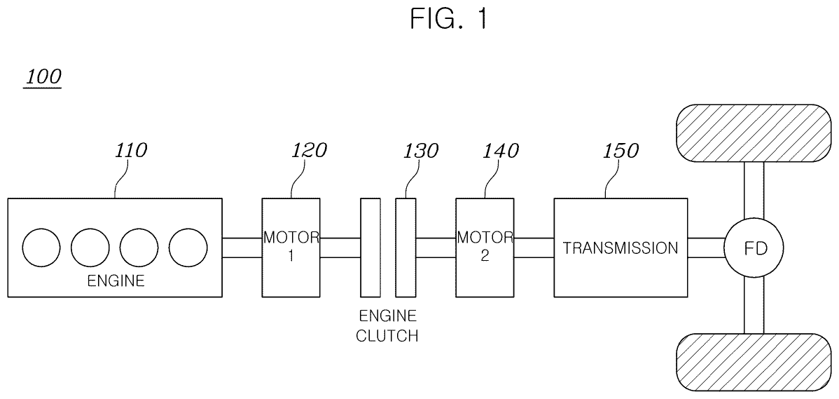

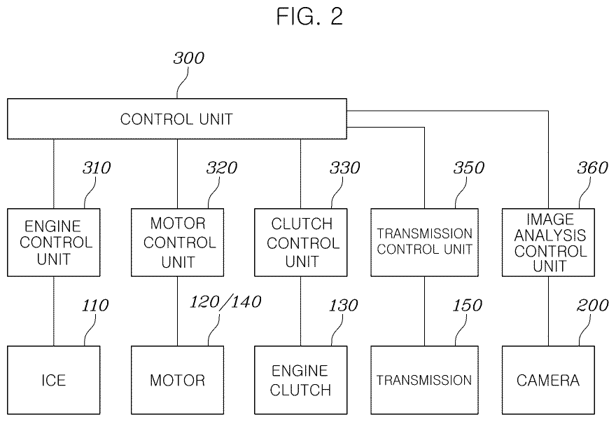

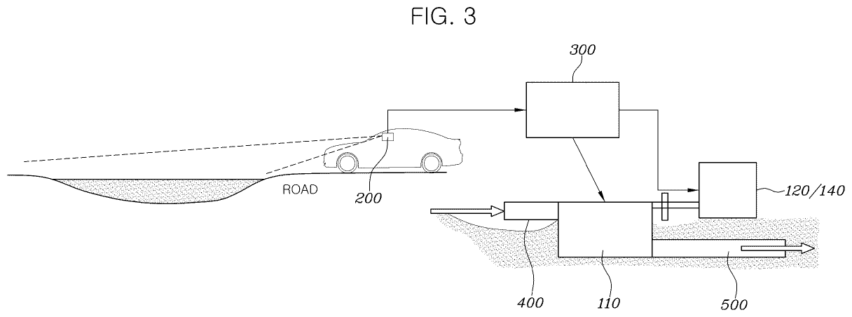

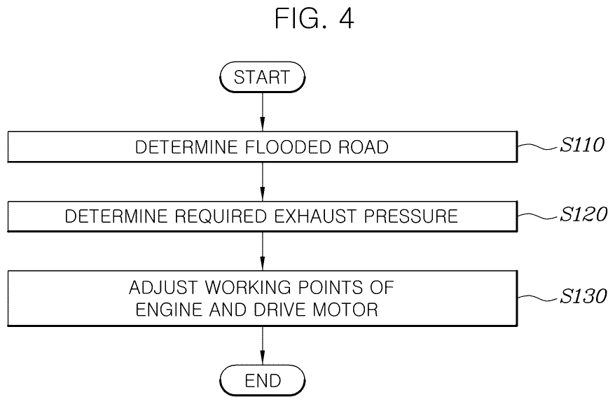

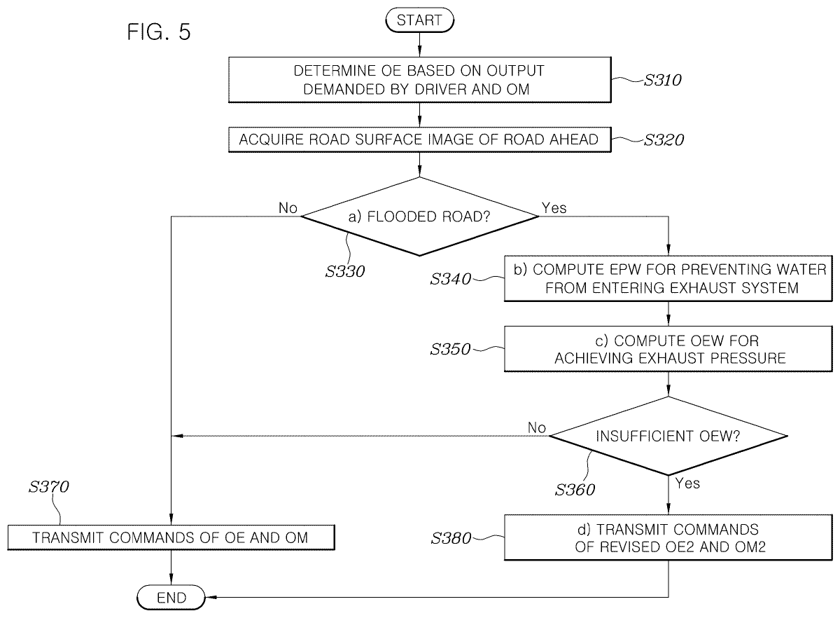

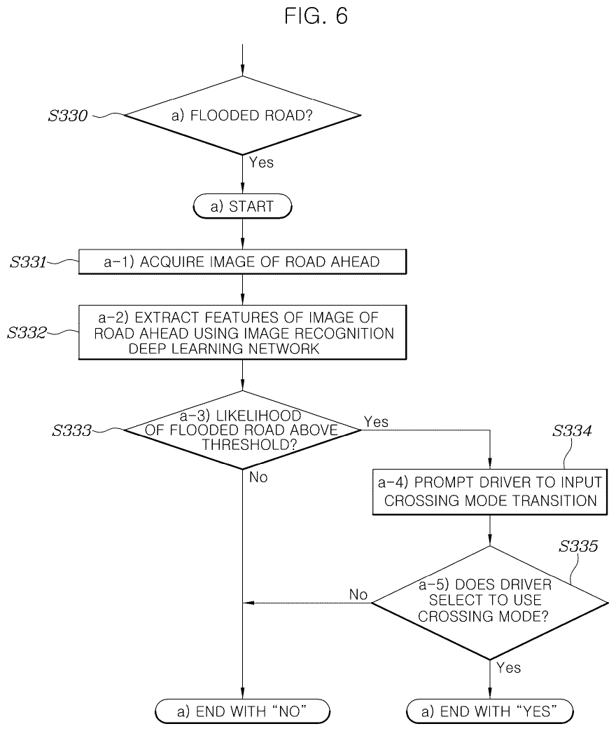

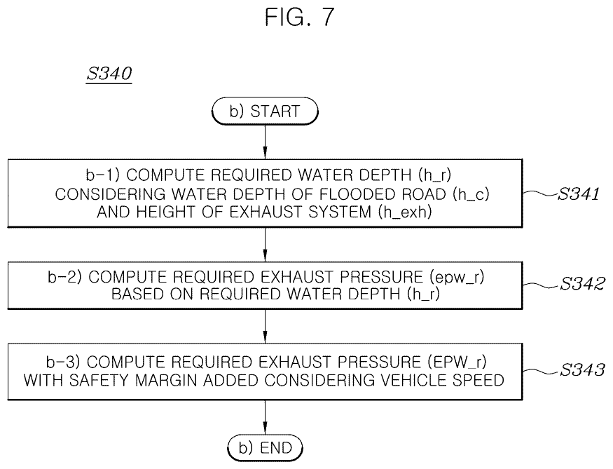

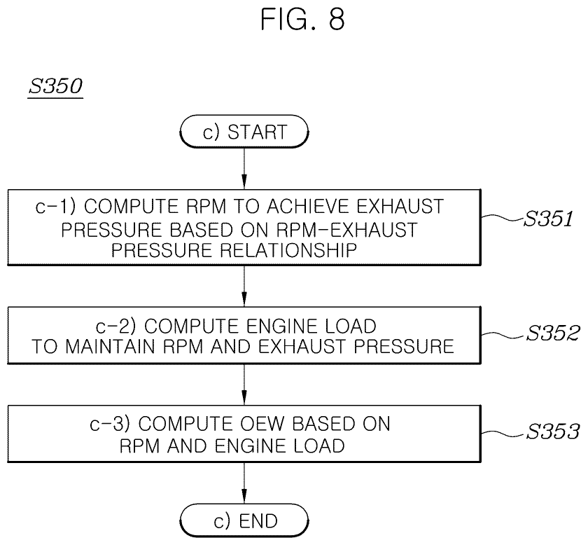

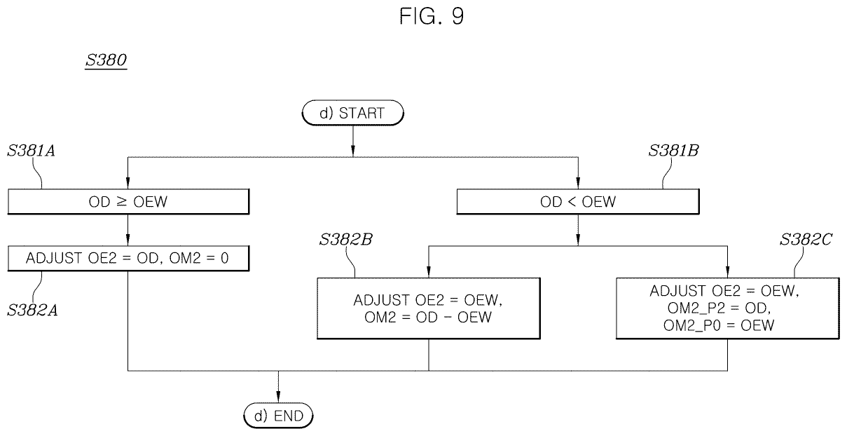

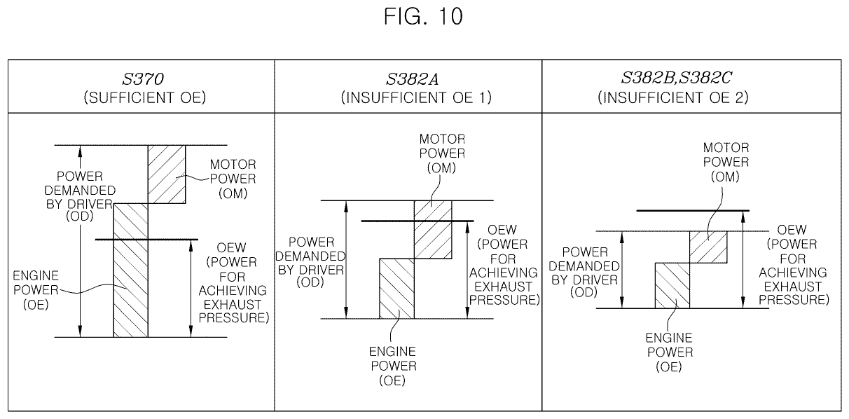

FIG. 1 is a view showing a hybrid powertrain of a hybrid electric vehicle according to an embodiment of the present disclosure. FIG. 2 is a view showing a control unit of a hybrid electric vehicle according to an embodiment of the present disclosure. FIG. 3 is a view showing an operation of a hybrid powertrain through a control unit when a hybrid electric vehicle crosses a flooded road according to an embodiment of the present disclosure. FIG. 4 is a flowchart showing a method of driving control for a hybrid electric vehicle according to an embodiment of the present disclosure. FIG. 5 is a detailed flowchart showing the method of driving control for a hybrid electric vehicle in FIG. 4 according to an embodiment of the present disclosure. FIG. 6 is a flowchart showing a method of determining whether a road is flooded in the method of driving control for a hybrid electric vehicle in FIG. 5 according to an embodiment of the present disclosure. FIG. 7 is a flowchart showing a method of computing required exhaust pressure in the method of driving control for a hybrid electric vehicle in FIG. 5 according to an embodiment of the present disclosure. FIG. 8 is a flowchart showing a method of computing an engine working point for achieving the required exhaust pressure in the method of driving control for a hybrid electric vehicle in FIG. 5 according to an embodiment of the present disclosure. FIGS. 9 and 10 are flowcharts showing a method of controlling an engine and a motor of a hybrid powertrain in the method of driving control for a hybrid electric vehicle in FIG. 5 according to an embodiment of the present disclosure.

Hereinafter, embodiments of the present specification are described in detail with reference to the drawings. The same reference numerals are given to the same or similar components, and a repetitive description thereof has been omitted.

When driving a vehicle on a flooded road, water may enter an engine or exhaust system and cause engine damage. Existing hybrid electric vehicle systems adjust the output of the engine and motor to optimize fuel efficiency and performance, but when driving on a flooded road, there is a risk of water entering the exhaust system as the engine stops or minimizes output. To address this, it is necessary to detect the state of the engine and exhaust system in real time and to manage exhaust pressure properly to prevent water entry. In addition, the cooperative operation between the motor and the engine is also required as a key technical element. Such technology is an essential element for ensuring safe driving on a flooded road and improving vehicle durability and driver safety.

To address the above problem, embodiments of the present disclosure provide a hybrid electric vehicle and a driving control method that enable safe driving on a flooded road, manage exhaust pressure properly to prevent water from entering an exhaust system 500 of an engine 110, and realize an output that meets the driver's demand through cooperation between the engine 110 and drive motors 120 and 140.

A hybrid electric vehicle, according to an embodiment of the present disclosure, is described in more detail with reference to FIGS. 1-3.

In an embodiment, the hybrid electric vehicle of the present disclosure may include a hybrid powertrain 100 and a control unit 300 (also sometimes referred to herein as “controller”). The hybrid powertrain 100 may include the engine 110 and the drive motors 120 and 140. The control unit 300 may determine whether a road ahead of the vehicle is a flooded road. If the road is determined to be the flooded road, the control unit 300 may adjust working points of the drive motors 120 and 140 and the engine 110 according to an output demanded by the driver, based on required exhaust pressure. The required exhaust pressure may be the exhaust pressure of the engine 110 needed to avoid or prevent flooding through an exhaust outlet 500.

FIG. 1 shows an example of the configuration of the hybrid powertrain 100 in the hybrid electric vehicle according to an embodiment of the present disclosure. With reference to FIG. 1, the powertrain 100 of the hybrid electric vehicle is shown that adopts a parallel-type hybrid system equipped with two motors 120 and 140 and an engine clutch 130 between the internal combustion engine (ICE) 110 and a transmission 150. This parallel-type hybrid system may be referred to as a transmission mounted electric drive (TMED) hybrid system, as the motor 140 is constantly connected to an input end of the transmission 150.

In an embodiment, a first motor 120 of the two motors 120 and 140 may be arranged between the engine 110 and an end of the engine clutch 130, and an engine shaft of the engine 110 and a first motor shaft of the first motor 120 may be directly connected to each other and constantly rotate together.

In an embodiment, one end of a second motor shaft of the second motor 140 may be connected to the other end of the engine clutch 130, and the other end of the second motor shaft may be connected to the input end of the transmission 150.

In an embodiment, the second motor 140 may have higher output compared to the first motor 120. The second motor 140 may serve as a drive motor. In addition, the first motor 120 may function as a starter motor that cranks the engine 110 during the starting of the engine 110. In the engine-off state, the first motor 120 may recover the rotational energy of the engine 110 through power generation. In the engine-running state, the first motor 120 may also perform power generation using power from the engine 110.

In an embodiment, since the first motor 120 and the second motor 140 may be fundamentally capable of both driving and power generation, the first motor 120 and the second motor 140 may function as a generator motor and a drive motor. However, when the engine clutch 130 is disengaged, the first motor 120 may exclusively perform power generation. Therefore, under this condition, the first motor 120 may function as a generator motor, and the second motor 140 may function as a drive motor.

In an embodiment, when the driver presses an accelerator pedal after starting in a hybrid electric vehicle equipped with the powertrain 100 shown in FIG. 1, the second motor 140 may be driven using power from a battery (not shown) first when the engine clutch 130 is open. Accordingly, power from the second motor 140 is transmitted through the transmission 150 and a final drive (FD) to move wheels (i.e., EV mode). As the vehicle gradually accelerates and requires progressively more driving force, the first motor 120 operates to crank the engine 110.

In an embodiment, when the difference in rotational speed between the engine 110 and the second motor 140 falls within a certain range after the engine 110 starts, the engine clutch 130 may engage, allowing the engine 110 and the second motor 140 to rotate together (i.e., transition from EV mode to HEV mode). Accordingly, through a process of torque blending, the output of the second motor 140 decreases, and the output of the engine 110 increases, thereby meeting the driver demand torque. In HEV mode, the engine 110 may meet most of the demand torque, and at least one of the first motor 120 and the second motor 140 may compensate for the difference between the torque of the engine 110 and the demand torque. For example, considering the efficiency of the engine 110, if the engine 110 outputs torque higher than the demand torque, either the first motor 120 or the second motor 140 generates power to compensate for surplus torque of the engine 110. If the torque of the engine 110 is insufficient compared to the demand torque, at least one of the first motor 120 and the second motor 140 may output insufficient torque.

In an embodiment, when a preset engine-off condition, such as deceleration of the vehicle, is satisfied, the engine clutch 130 may open, and the engine 110 may stop (i.e., transition from HEV mode to EV mode). During deceleration, the battery is charged through the second motor 140 using the driving force of the wheel, which may be referred to as brake energy regeneration, or regenerative braking.

In an embodiment, the transmission 150 may generally be a stepped transmission or a multi-plate clutch, for example, a dual-clutch transmission (DCT).

FIG. 2 shows the configuration of a control unit in a hybrid electric vehicle according to an embodiment of the present disclosure. With reference to FIG. 2, in a hybrid electric vehicle to which embodiments of the present disclosure may be applied, the internal combustion engine 110 may be controlled by an engine control unit 310, the torque of the first motor 120 and the second motor 140 may be controlled by a motor control unit (MCU) 320, and the engine clutch 130 may be controlled by a clutch control unit 330. In this configuration, the engine control unit 310 may also be referred to as an engine management system (EMS). In addition, the transmission 150 may be controlled by a transmission control unit 350, and an image analysis control unit 360 using a camera 200 may receive road surface image information ahead of the vehicle and determine whether the road ahead is flooded.

In an embodiment, each control unit 310, 320, 330, 350, and 360 is connected to the control unit 300, which serves as a higher-level control unit configured to control the overall powertrain 100, including the mode transition process. Based on the control of the control unit 300, each control unit may provide information required to control the engine clutch 130 during driving mode changes and gear shifting, information required for stop control of the engine 110, and/or road surface image information to the control unit 300, or may perform operations in response to control signals.

In an embodiment, for example, the control unit 300 may determine whether to perform a mode transition between EV-HEV modes or between CD-CS modes (for PHEVs) based on the vehicle's operating state. To this end, the control unit 300 may determine the timing for opening the engine clutch 130 and perform hydraulic control during the opening. In addition, the control unit 300 may determine the state of the engine clutch 130 and control the timing of fuel injection cutoff for the engine 110. In addition, the control unit 300 may transmit a torque command to the motor control unit 320 to control the torque of the first motor 120 for stop control of the engine 110, thereby controlling the recovery of rotational energy from the engine 110. In addition, the control unit 300 may determine the state of each drive source 110, 120 and 140 to meet the demand torque, accordingly determine the required driving force to be allocated to each drive source 110, 120 and 140, and transmit a torque command to the control units 310 and 320 to control each drive source.

It should be apparent to those having ordinary skill in the art that the above-described interconnections between control units and the functions or classifications of each control unit are illustrative and are not limited by the names. For example, the function of the control unit 300 may be implemented by being replaced with that of any one of the other control units, excluding the control unit 300, or may be distributed across two or more of the other control units.

The configuration of the above-described FIGS. 1 and 2 is merely one example of a hybrid electric vehicle configuration, and it should be apparent to those having ordinary skill in the art that the hybrid electric vehicle relevant to the embodiment is not limited to this structure.

FIG. 3 shows operation of the hybrid powertrain 100 through the control unit 300 when the hybrid electric vehicle crosses a flooded road, according to an embodiment of the present disclosure.

In an embodiment, a method of recognizing a flooded road may be image acquisition using the camera 200. The high-resolution camera 200, mounted inside and/or outside the vehicle, may capture a road surface image of the road ahead in real time and transmit this road surface image information to the control unit 300. The control unit 300 may analyze the state of the road surface using an image processing algorithm and accurately recognize a flooded area. For example, image recognition technology and deep learning-based object recognition algorithms may be used to extract the features of a flooded road, and the extracted features are used as criteria for determining whether the road is flooded.

In an embodiment, flood depth estimation and exhaust pressure control are important factors in the crossing process, and may include increasing the exhaust pressure to prevent water from entering the exhaust system 500 of the vehicle. The control unit 300 may estimate water depth on a flooded road and compute an appropriate value for adjusting the exhaust pressure based on the estimated water depth. For example, the exhaust pressure may be required exhaust pressure of the engine 110 needed to avoid or prevent flooding through the exhaust outlet 500. In addition, the control unit 300 may use a water pressure formula to estimate the required exhaust pressure based on water depth or may use a preset table to compute the relationship between water depth and required exhaust pressure. Accordingly, the control unit 300 may transmit an output command to the engine 110 via the engine control unit 310 in order to increase and maintain the exhaust pressure above a certain level, thereby preventing water from entering the exhaust system 500 of the vehicle and enabling stable driving.

In an embodiment, if the output of the engine 110 exceeds the output demanded by the driver, the control unit 300 may command the motor control unit 320 so that the surplus output may be controlled through the drive motors 120 and 140. For example, the control unit 300 may control the output of engine 110 to be transmitted to the wheels by exclusively realizing the required output through the drive motors 120 and 140, without directly transmitting the surplus output of the engine 110 to the wheels. This control may be implemented through a disengagement method of the engine clutch 130 or a generation method using the drive motors 120 and 140. The surplus output of the engine 110 may be utilized by generating power through the drive motors 120 and 140, and the resulting power may be used to charge the battery (not shown). This may reduce the burden on the engine 110 and optimize the vehicle's fuel efficiency and performance.

In an embodiment, after safely passing through the flooded road, the control unit 300 may recognize that the vehicle has passed through a flooded area and terminate the control. This process confirms that the crossing has been safely completed based on real-time sensor data, and allows the control of the engine 110 and the drive motors 120 and 140 to be restored to their original states. Following termination of the control, the driving state of the vehicle is restored to normal, which allows for further driving. Through this, vehicle stability and performance may be maintained even after passing through the flooded area, and the driver is able to continue normal driving seamlessly without any additional operation after leaving the flooded area.

In an embodiment, a method of driving control for the hybrid electric vehicle of the present disclosure may be performed as shown in FIG. 5.

In an operation S310, the control unit 300 may determine a working point (OE) of the engine 110 and working points (OM) of the drive motors 120 and 140 based on the output demanded by the driver. For example, when the driver operates an accelerator pedal or brake pedal, the control unit 300 may compute the driver demand torque. Based on this torque, the control unit 300 may set initial working point (OE) of the engine 110 and working points (OM) of the drive motors 120 and 140.

In an operation S320, the vehicle may acquire a road surface image in the driving direction through the front camera 200 or sensors. In an operation S330, the control unit 300 may analyze the road surface image input through the camera 200 or sensors and determine whether a flooded road is present ahead of the vehicle. If the road is not flooded (NO in the operation S330), normal driving may be performed based on the commands of the initially set working point of the engine 110 and working points of the drive motors 120 and 140 in an operation S370.

In an embodiment, if the control unit 300 determines that there is a flooded road ahead of the vehicle (YES in the operation S330), the control unit 300 may take additional safety measures. Specifically, in an operation S340, the control unit 300 may compute required exhaust pressure needed to prevent water from entering the exhaust system 500. The control unit 300 may also compute a working point (OEW) of the engine 110 to achieve the required exhaust pressure in an operation S350. If the working point of the engine 110 is insufficient (YES in an operation S360), and more power of the engine 110 is required to achieve the required exhaust pressure, the control unit 300 may recompute the revised working point (OE2) of the engine 110 and the revised working points (OM2) of the drive motors 120 and 140 in an operation S380. However, if the working point of the engine 110 is sufficient (NO in the operation S360), vehicle driving may be performed based on the determined working point (OEW) of the engine 110 and the working points (OM) of the drive motors 120 and 140 in an operation S370.

In an embodiment, the hybrid electric vehicle of the present disclosure may further include the camera 200 installed in the vehicle to acquire road surface images of the road ahead. The control unit 300 may receive road surface image information from the camera 200 and determine whether the road ahead is a flooded road based on the road surface image information. In addition, if the control unit 300 determines that the road ahead is a flooded road, the control unit 300 may output information prompting the driver to input a crossing mode transition through a display device of the vehicle. A more detailed description of the method of determining whether the road is flooded in the hybrid electric vehicle of the present disclosure, according to an embodiment, is provided below with reference to FIGS. 5 and 6.

In an embodiment, the control unit 300 of the hybrid electric vehicle of the present disclosure may provide a function that analyzes the condition of the road on which the vehicle drives in real time and recognizes a flooded road. For example, the control unit 300 may acquire a road area in the driving direction from a front image using the camera 200 in an operation S331, may extract features of the road using an image recognition deep learning network in an operation S332, and based on the extracted features, may determine whether the road corresponds to a flooded road in an operation S333. If the road is highly likely to be flooded (YES in the operation S333), the control unit 300 may display a message enabling the driver to select whether to use the crossing mode in an operation S334. In an operation S335, the control unit 300 may determine whether the driver has confirmed the message and has selected to use the crossing mode. The driver may confirm the message through a cluster screen or an information display device and make a selection through a steering wheel or touchscreen, for example. When the crossing mode is activated (YES in the operation S335), the vehicle is controlled to safely pass through the flooded road. If the driver does not choose the crossing mode (NO in the operation S335) or if the likelihood of a flooded road is low (NO in the operation S333), the control unit 300 may control the vehicle to return to the normal driving mode.

In an embodiment, the control unit 300 of the hybrid electric vehicle according to an embodiment of the present disclosure may determine required exhaust pressure of the engine 110 based on the difference between the water depth of a flooded road and the height of the exhaust outlet 500 of the vehicle. This is described in more detail with reference to the flowcharts shown in FIGS. 5 and 7.

In an operation S341, when the hybrid electric vehicle according to an embodiment of the present disclosure crosses a flooded road, the control unit 300 may compute water depth to prevent water from entering the exhaust system 500 including the exhaust outlet 500. In an operation S342, based on the computed water depth, the control unit 300 may determine required exhaust pressure to control the engine 110. This allows the hybrid electric vehicle to safely pass through the flooded road.

In an operation S341, the control unit 300 may compute required water depth to determine required exhaust pressure, taking into account the water depth of a flooded road and the height of the exhaust outlet 500, which is included in the exhaust system. For example, the control unit 300 may compute the required water depth using the difference between the water depth of a flooded road and the height of the exhaust system 500. Since an intake system 400 is positioned higher than the exhaust system 500 in most vehicles, the control unit 300 may determine the required water depth as the difference between the current water depth of the flooded road and the height of the exhaust system 500, and based on this, determine the required exhaust pressure. Alternatively, a preset lookup table may be utilized to estimate the water depth.

In an operation S342, the control unit 300 may compute the required exhaust pressure based on the computed required water depth. For example, the required exhaust pressure may be computed using a pressure formula or estimated using a preset lookup table. For example, the pressure formula may be determined by the product of density, gravitational acceleration, and the required water depth.

In an operation S343, the control unit 300 may determine the required exhaust pressure, which incorporates a safety margin to take into account factors such as vehicle speed. For example, as the vehicle speed increases, the likelihood of water entering the exhaust system 500 may increase. Additionally, the water depth of a flooded road may vary depending on the road conditions, and there may be other unforeseen risk factors. Therefore, a safety margin may be incorporated to take into account these factors. The required exhaust pressure, incorporating a safety margin, may be a value obtained by adding parameter values such as vehicle speed, using a preset lookup table or the like, to the exhaust pressure determined in the above process.

A process of determining a working point (OEW) of the engine 110 based on the required exhaust pressure, according to an embodiment, is described in more detail below with reference to FIGS. 5 and 8.

In an embodiment, the control unit 300 of the hybrid electric vehicle according to the present disclosure may compute the optimal working point based on the required exhaust pressure to prevent damage to the engine 110 and enable stable crossing of a flooded road. Specifically, the control unit 300 may compute the RPM of the engine 110 in an operation S351 and may compute the load of the engine 110 in an operation S352, and based on these, may compute the optimal engine working point (OEW) of the engine 110 in operation S353. In this process, a preset table may be utilized.

In an embodiment, the control unit 300 may determine the RPM for maintaining the required exhaust pressure, determined through computation, from a preset table in the operation S351, and may determine the load of the engine 110 by inputting the determined RPM and the required exhaust pressure into a preset table in the operation S352. In an operation 353, the working point of the engine 110 may be determined based on the determined RPM and the load of the engine 110, and this may also be determined through a preset table. For example, the preset table may be a brake specific fuel consumption (BSFC) map.

Subsequently, with reference to FIGS. 5, 9, and 10, a method is described in which the control unit 300 adjusts the working points of the engine 110 and the drive motors 120 and 140, based on a comparison between the working points of the drive motors 120 and 140 and the engine 110 based on the output demanded by the driver, and the working point required for the engine 110 to achieve the required exhaust pressure needed to avoid or prevent flooding through the exhaust outlet 500, according to an embodiment.

The left-most diagram in the table of FIG. 10 shows that the output demanded by the driver (OD) is higher than or equal to the working point (OEW) to achieve the exhaust pressure, and the output (OE) of the engine 110 is higher than the working point (OEW) to achieve the exhaust pressure. Under this condition, the control unit 300 may determine that the working point of the engine 110 is sufficient and determine that it is possible to cross a flooded road. Accordingly, the control unit 300 may control the engine 110 to generate an output capable of increasing and maintaining exhaust pressure, which allows the vehicle to pass through a flooded road as the exhaust pressure increases.

In an embodiment, a second diagram in the table of FIG. 10 may show that the output demanded by the driver (OD) is higher than or equal to the working point (OEW) to achieve the exhaust pressure (S381A), but the output (OE) of the engine 110 is lower than the working point (OEW) to achieve the exhaust pressure. This may be a condition in which the exhaust pressure at the working point of the engine 110 based on the output demanded by the driver (OD) is higher than or equal to the required exhaust pressure of the engine 110 needed to avoid or prevent flooding through the exhaust outlet 500. Under this condition, the control unit 300 may determine that the working point of the engine 110 is insufficient.

Referring also to FIG. 9, if the exhaust pressure at the working point of the engine 110 based on the output demanded by the driver (OD) is higher than or equal to the required exhaust pressure of the engine 110 needed to avoid or prevent flooding through the exhaust outlet 500, as determined in an operation S381A, the control unit 300 may maintain the working point of the engine 110 based on the output demanded by the driver in an operation S382A. Under the condition that the working point of the engine 110 is insufficient, the control unit 300 may stop the output assistance of the drive motors 120 and 140 and may need to use the engine 110 exclusively to meet the output demanded by the driver (OD) in the operation S382A. In other words, the control unit 300 may control the output (OE2) of the engine 110 to be equal to the output demanded by the driver (OD), and may control the output (OM2) of the drive motors 120 and 140 to be zero in the operation S382A. This enables exclusive control of the engine 110 to achieve the required exhaust pressure when the vehicle drives on a flooded road.

The right-most diagram in the table of FIG. 10 may indicate a condition in which both the output demanded by the driver (OD) and the output (OE) of the engine 110 are lower than the working point (OEW) to achieve the exhaust pressure (as determined in an operation S381B in FIG. 9). This may indicate a condition in which the exhaust pressure at the working point of the engine 110, based on the output demanded by the driver, is lower than the required exhaust pressure of the engine 110 needed to avoid or prevent flooding through the exhaust outlet 500 in the operation S381B. Under this condition, the control unit 300 may adjust the working point of the engine 110 to achieve at least the minimum exhaust pressure, and any surplus output may be generated through the drive motors 120 and 140 in the operation S382B.

In an embodiment, the control unit 300 may adjust the working point of the engine 110, based on the output demanded by the driver (OD), to a working point (OEW) for achieving the required exhaust pressure, and may adjust the working points of the drive motors 120 and 140 so that the difference (OD-OEW) between the output (OE2=OEW) of the engine 110, based on the adjusted working point of the engine 110, and the output demanded by the driver (OD) is output (OM2) from the drive motors 120 and 140 in the operation S382B.

In an embodiment, the hybrid electric vehicle of the present disclosure may further include the engine clutch 130, arranged between the engine 110 and the drive motors 120 and 140 and configured to selectively connect the engine 110 and the drive motors 120 and 140. If the output demanded by the driver is within an available output of the drive motors 120 and 140, the control unit 300 may disengage the engine clutch 130, adjust the working point of the engine 110 based on the output demanded by the driver (OD) to a working point (OEW) for achieving the required exhaust pressure, and adjust the working point of the drive motors 120 and 140 to correspond to the output demanded by the driver (OD). In other words, since the output (OE2) of the engine 110 becomes higher than the output demanded by the driver (OD), the higher output (OE2) of the engine 110 may need to be controlled to avoid transmission to the wheels.

In an embodiment, the hybrid powertrain 100 may further include a generator motor 120. Under the condition that the hybrid powertrain 100 includes the generator motor 120 and is configured with two motors 120 and 140, if the exhaust pressure at the working point of the engine 110 based on the output demanded by the driver is lower than the required exhaust pressure of the engine 110 needed to avoid or prevent flooding through the exhaust outlet 500, the control unit 300 may adjust the working point of the engine 110 based on the output demanded by the driver (OD) to a working point (OEW) for achieving the required exhaust pressure, adjust the working point of the generator motor 120 so that the output (OE2) of the engine 110, based on the adjusted working point of the engine 110, is output (OM2_P0) from the generator motor 120, and adjust the working point of the drive motor 140 so that the output demanded by the driver (OD) is output (OM2_P2) from the drive motor 140 (S382C).

In an embodiment, to safely pass through a flooded road, the working points of the drive motors 120 and 140 and the engine 110, based on the output demanded by the driver, may be higher than or equal to the working point required for the engine 110 to achieve the required exhaust pressure needed to avoid or prevent flooding through the exhaust outlet 500.

Subsequently, with reference to FIGS. 4-10, a method of driving control for a hybrid electric vehicle according to an embodiment of the present disclosure is described. However, the description of the system in the hybrid electronic vehicle of the present disclosure, as described above, has been omitted to avoid redundancy.

In an embodiment, the method of driving control for a hybrid electric vehicle of the present disclosure may include an operation S110 of determining a flooded road, an operation S120 of determining required exhaust pressure, and an operation S130 of adjusting working points of the engine 110 and the drive motors 120 and 140. Each step may be controlled by the control unit 300.

In an embodiment, as shown in FIGS. 5 and 6, in the operation S110 of determining a flooded road, the control unit 300 may receive road surface image information from the camera 200, installed in the vehicle and configured to acquire road surface images of the road ahead (operation S320), and based on the road surface image information, determine whether the road ahead is a flooded road (operation S330). In addition, if the control unit 300 determines that the road on which the vehicle currently drives is the flooded road (YES in the operation S330in FIG. 5), the control unit 300 may output information prompting the driver to input a crossing mode transition through a display device of the vehicle (operation S334).

In an embodiment, as shown in FIGS. 5 and 7, in the operation S120 of determining required exhaust pressure, the control unit 300 may determine the required exhaust pressure of the engine 110 based on the difference between the water depth (operation S341) of the flooded road and the height of the vehicle's exhaust outlet 500 (operation S342). Subsequently, the control unit 300 may determine the working point (operation S353) of the engine 110 based on the required exhaust pressure, which may be as shown in FIG. 8.

In an embodiment, as shown in FIGS. 5, 9, and 10, the control unit 300 may adjust the working points of the engine 110 and the drive motors 120 and 140.

In an embodiment, in the operation S130 of adjusting working points of the engine 110 and the drive motors 120 and 140, if the exhaust pressure at the working point of the engine 110 based on the output demanded by the driver is higher than or equal to the required exhaust pressure of the engine 110 needed to avoid or prevent flooding through the exhaust outlet 500 (operation S381A), the control unit 300 may maintain the working point of the engine 110 based on the output demanded by the driver (operation S382A).

In an embodiment, in the operation S130 of adjusting working points of the engine 110 and the drive motors 120 and 140, if the exhaust pressure at the working point of the engine 110 based on the output demanded by the driver is lower than the required exhaust pressure of the engine 110 needed to avoid or prevent flooding through the exhaust outlet 500 (operation S381B), the control unit 300 may adjust the working point of the engine 110 based on the output demanded by the driver to a working point for achieving the required exhaust pressure, and may adjust the working point of the drive motors 120 and 140 so that the difference between the output of the engine 110 based on the adjusted working point of the engine 110 and the output demanded by the driver is output through the drive motors 120 and 140 (operation S382B).

In an embodiment, in the operation S130 of adjusting working points of the engine 110 and the drive motors 120 and 140, if the working points of the engine 110 and the drive motors 120 and 140 are to be adjusted, the hybrid electric vehicle may further include the engine clutch 130, arranged between the engine 110 and the drive motors 120 and 140 and configured to selectively connect the engine 110 and the drive motors 120 and 140. If the output demanded by the driver is within an available output of the drive motors 120 and 140, the control unit 300 may disengage the engine clutch 130, may adjust the working point of the engine 110 based on the output demanded by the driver to a working point for achieving the required exhaust pressure, and may adjust the working point of the drive motors 120 and 140 to correspond to the output demanded by the driver.

In an embodiment, in the operation S130 of adjusting working points of the engine 110 and the drive motors 120 and 140, if the working points of the engine 110 and the drive motors 120 and 140 are to be adjusted, the hybrid powertrain 100, which includes the engine 110 and the drive motor 140, may further include the generator motor 120. If the exhaust pressure at the working point of the engine 110 based on the output demanded by the driver is lower than the required exhaust pressure of the engine 110 needed to avoid or prevent flooding through the exhaust outlet 500 (operation S381B), the control unit 300 may adjust the working point of the engine 110 based on the output demanded by the driver to a working point for achieving the required exhaust pressure, may adjust the working point of the generator motor 120 so that the output of the engine 110 based on the adjusted working point of the engine 110 is output from the generator motor 120, and may adjust the working point of the drive motor 140 so that the output demanded by the driver is output from the drive motor 140 (operation S382C).

In an embodiment, in the operation S130 of adjusting working points of the engine 110 and the drive motors 120 and 140, the working points of the drive motors 120 and 140 and the engine 110 based on the output demanded by the driver may be higher than or equal to a working point for achieving the required exhaust pressure of the engine 110 needed to avoid or prevent flooding through the exhaust outlet 500.

According to some embodiments, the hybrid electric vehicle and the driving control method therefor may enable safe driving on a flooded road, thereby assisting in the vehicle to prevent damage to the engine 110 and to stably cross even in a flooded environment. Embodiments of the present disclosure properly control the vehicle's exhaust pressure and, through the cooperative operation of the engine 110 and drive motors 120 and 140, ensure both the vehicle's efficiency and safety, thereby improving driving stability.

Although the specific embodiments of the present disclosure have been described and illustrated, those having ordinary skill in the art should appreciate that various alternations and modifications are possible without departing from the technical spirit of the present disclosure provided in the appended claims.

What is claimed is:

1. A hybrid electric vehicle, comprising:
a hybrid powertrain having an engine and a drive motor; and
a control unit configured to i) determine whether a road ahead of the hybrid electric vehicle is flooded and ii) adjust working points of the drive motor and the engine according to an output demanded by a driver, based on a required exhaust pressure of the engine to avoid flooding through an exhaust outlet, in response to determining that the road ahead is flooded.

2. The hybrid electric vehicle of claim 1, further comprising:
a camera configured to acquire a road surface image of the road ahead,
wherein the control unit is configured to receive road surface image information from the camera and determine whether the road ahead is flooded based on the road surface image information.

3. The hybrid electric vehicle of claim 1, wherein the control unit is further configured to, in response to determining that the road ahead is flooded, output information prompting the driver to input a crossing mode transition through a display device of the vehicle.

4. The hybrid electric vehicle of claim 1, wherein the control unit is configured to determine the required exhaust pressure of the engine based on a difference between a water depth of the road ahead and a height of the exhaust outlet of the vehicle.

5. The hybrid electric vehicle of claim 1, wherein the control unit is configured to, in response to determining that exhaust pressure at the working point of the engine based on the output demanded by the driver is higher than or equal to the required exhaust pressure of the engine, maintain the working point of the engine based on the output demanded by the driver.

6. The hybrid electric vehicle of claim 1, wherein in response to determining that exhaust pressure at the working point of the engine based on the output demanded by the driver is lower than the required exhaust pressure of the engine, the control unit is configured to i) adjust the working point of the engine based on the output demanded by the driver to a working point configured to achieve the required exhaust pressure and ii) adjust the working point of the drive motor so that a difference between an output of the engine based on the adjusted working point of the engine and the output demanded by the driver is output from the drive motor.

7. The hybrid electric vehicle of claim 1, further comprising:
an engine clutch arranged between the engine and the drive motor and configured to selectively connect the engine and the drive motor,
wherein the control unit is configured to, in response to determining that the output demanded by the driver is within an available output of the drive motor, i) disengages the engine clutch, ii) adjust the working point of the engine based on the output demanded by the driver to a working point configured to achieve the required exhaust pressure, and iii) adjust the working point of the drive motor to correspond to the output demanded by the driver.

8. The hybrid electric vehicle of claim 1, wherein:
the hybrid powertrain further comprises a generator motor; and
the control unit is configured to, in response to determining that exhaust pressure at the working point of the engine based on the output demanded by the driver is lower than the required exhaust pressure of the engine, i) adjust the working point of the engine based on the output demanded by the driver to a working point configured to achieve the required exhaust pressure, ii) adjust the working point of the generator motor so that an output of the engine based on the adjusted working point of the engine is output from the generator motor, and iii) adjust the working point of the drive motor so that the output demanded by the driver is output from the drive motor.

9. The hybrid electric vehicle of claim 1, wherein the working points of the drive motor and the engine based on the output demanded by the driver are higher than or equal to the working point required for the engine to achieve the required exhaust pressure of the engine.

10. A method of driving control for a hybrid electric vehicle, the method comprising:
determining, by a control unit, whether a road ahead of the hybrid electric vehicle is flooded;
determining, by the control unit, required exhaust pressure of an engine to avoid flooding through an exhaust outlet, in response to determining that the road ahead is flooded; and
adjusting, by the control unit, working points of the engine and a drive motor based on an output demanded by a driver based on the required exhaust pressure.

11. The method of claim 10, wherein determining whether the road ahead of the hybrid electric vehicle is flooded includes:
receiving, by the control unit, road surface image information from a camera installed in the hybrid electric vehicle and configured to acquire a road surface image of the road ahead; and
determining, by the control unit, whether the road ahead is flooded based on the road surface image information.

12. The method of claim 10, further comprising, in response to determining that the road ahead is flooded, outputting, by the control unit, information prompting the driver to input a crossing mode transition through a display device of the hybrid electric vehicle.

13. The method of claim 10, determining the required exhaust pressure of the engine includes determining the required exhaust pressure of the engine based on a difference between a water depth of the road ahead and a height of the exhaust outlet of the hybrid electric vehicle.

14. The method of claim 10, wherein adjusting the working points of the engine and the drive motor includes, in response to determining that exhaust pressure at the working point of the engine based on the output demanded by the driver is higher than or equal to the required exhaust pressure of the engine, maintaining the working point of the engine based on the output demanded by the driver.

15. The method of claim 10, wherein adjusting the working points of the engine and the drive motor includes, in response to determining that exhaust pressure at the working point of the engine based on the output demanded by the driver is lower than the required exhaust pressure of the engine, i) adjusting the working point of the engine based on the output demanded by the driver to a working point configured to achieve the required exhaust pressure and ii) adjusting the working point of the drive motor so that a difference between an output of the engine based on the adjusted working point of the engine and the output demanded by the driver is output from the drive motor.

16. The method of claim 10, wherein adjusting the working points of the engine and the drive motor includes, in response to determining that the output demanded by the driver is within an available output of the drive motor, i) disengaging an engine clutch arranged between the engine and the drive motor and configured to selectively connect the engine and the drive motor, ii) adjusting the working point of the engine based on the output demanded by the driver to a working point configured to achieve the required exhaust pressure, and iii) adjusting the working point of the drive motor to correspond to the output demanded by the driver.

17. The method of claim 10, wherein adjusting the working points of the engine and the drive motor includes, in response to determining that exhaust pressure at the working point of the engine based on the output demanded by the driver is lower than the required exhaust pressure of the engine, i) adjusting the working point of the engine based on the output demanded by the driver to a working point configured to achieve the required exhaust pressure, ii) adjusting the working point of a generator motor so that an output of the engine based on the adjusted working point of the engine is output from the generator motor, and iii) adjusting the working point of the drive motor so that the output demanded by the driver is output from the drive motor.

18. The method of claim 10, the working points of the drive motor and the engine based on the output demanded by the driver are higher than or equal to the working point required for the engine to achieve the required exhaust pressure of the engine.
